(19) United States
(12) Patent Application Publication
(10) Pub. No.: US 2006/0078136 A1
(43) Pub. Date: Apr. 13, 2006

(54) Chamber-loaded augmented passive radiator

(76) Inventors: Enrique M. Stiles, Imperial Beach, CA (US); Richard C. Calderwood, Portland, OR (US)

Correspondence Address: RICHARD C. CALDERWOOD, 2775 NW 126TH AVE, PORTLAND, OR, 97229-8381, US

(21) Appl. No.: 10/960,418

(22) Filed: Oct. 7, 2004

(51) Int. Cl. H04R 25/00; H04R 1/02; H04R 1/20

(52) U.S. Cl. 381/182; 381/349; 381/345

(57) ABSTRACT

A loudspeaker in which an electromagnetic transducer drives a chamber-loaded augmented passive radiator (APR). The loudspeaker uses a bandpass enclosure such that the transducer produces sound pressure directly into a listening space, and the APR produces sound pressure into the listening space via an acoustic coupler through a chamber which loads the large diaphragm of the APR. The augmented passive radiator enhances low frequency output, permitting the use of a smaller electromagnetic transducer, which in turn improves high frequency output. This improved loudspeaker system may be used in stand-alone loudspeakers, in-ceiling or in-wall loudspeakers, automotive loudspeakers, pro-audio loudspeakers, and in other applications.

### RELATED APPLICATION

This application is a continuation-in-part of a co-pending application Ser. No. 10/______ entitled “Thermal Chimney Equipped Audio Speaker Cabinet” filed on or about Jan. 29, 2004 by Enrique M. Stiles and Richard C. Calderwood.

### BACKGROUND OF THE INVENTION

1. Technical Field of the Invention

This invention relates generally to enclosures for audio speakers, and more specifically to an improved enclosure for an augmented passive radiator (APR) system.

2. Background Art

Passive radiators are well-known in the audio speaker art. A passive radiator is a radiating diaphragm which is suspended by a compliant suspension component, typically a surround, and whose back surface shares an enclosed air volume with that of an active transducer. Movements of the active transducer's diaphragm pressurize and depressurize the enclosed air volume, and the oscillating pressure causes the passive radiator to vibrate. Within a frequency range, typically a low frequency range, for which the overall system is tuned, sound produced by the front surface of the passive radiator adds to sound produced by the front surface of the transducer's diaphragm, increasing the overall sound pressure level produced by the speaker system.

U.S. Pat. No. 4,076,097 “Augmented Passive Radiator Loudspeaker” to Clarke, U.S. Pat. No. 4,301,332 “Woofer Loudspeaker” to Dusanek, and U.S. Pat. No. 6,782,112 “Low Frequency Transducer Enclosure” to Geddes relate to a series of improvements in passive radiator loudspeaker systems.

FIG. 1 (copied from Clarke's FIG. 2) illustrates the basic configuration of an augmented passive radiator (APR) loudspeaker system. The fundamental principle is that the entire front surface of the passive radiator is in contact with the ambient air into which the front surface of the active transducer's diaphragm is generating sound, but only a net portion of the back surface of the passive radiator is in contact with the enclosed air volume which the back surface of the active transducer's diaphragm is de/pressurizing. This system acts as an “acoustic lever” (in Gedde' lexicon). Clarke's active transducer 11 includes a motor structure 3 coupled to a diaphragm 2. A first surround 1 suspends and seals the diaphragm within a first hole through the front of the enclosure 10. Clarke's passive radiator includes a conical portion 6 rigidly coupled to a flat portion 7. A second surround 4 suspends and seals the outer diameter (OD) of the conical portion within a second hole through the front of the enclosure. A third surround suspends and seals the OD of the flat portion within a hole through an enclosure partition 13. The enclosure, enclosure partition, transducer diaphragm, transducer surround, conical portion 6 of the augmented passive radiator, and the augmented passive radiator surrounds 4, 5 together enclose a sealed air volume 8. The back surface of the conical portion of the passive radiator is in contact with this enclosed air volume, while the back surface of the flat portion of the passive radiator is not. This surface is in contact with a separate enclosed air volume 15 or, (in the case of Clarke's FIG. 3) it can be exposed to the ambient air.

FIGS. 2 and 3 (copied from Dusanek's FIGS. 7 and 8, respectively) illustrate a very similar loudspeaker enclosure. The APR, except for the back surface of a cone 34 (analogous to Clarke's flat portion 7) and the front surface of an output cone 32 (whose outer portion is analogous to Clarke's conical portion 6), is contained within a self-enclosed cylindrical housing 40. In order to put the back surface of the output cone in contact with the same upper enclosed air volume 30 as the back surface of the active transducer 31, the housing 40 includes a port 37 which is mated with an opening through an internal baffle 33 which separates the upper enclosed air volume from a lower enclosed air volume. The back surface of the cone 34 is in contact with this lower enclosed air volume.

FIG. 4 (copied from Geddes' FIG. 5) illustrates a somewhat different loudspeaker enclosure. Rather than broadcasting directly into the ambient air, the front surface of the active transducer 70 generates sound pressure into an enclosed air volume 30. The driven surface 85 of the APR assembly 80 is in contact with this enclosed air volume, and only the opposite surface 81 of the APR assembly is exposed to the ambient air. The back surface of the active transducer's diaphragm is in contact with a separate enclosed air volume 40.

FIG. 5 (copied from Geddes' FIG. 8) illustrates a similar loudspeaker enclosure, which differs from that of FIG. 4 by the addition of a second APR assembly 160 whose driven surface is in contact with the same separate enclosed air volume 120 as is the back surface of the diaphragm of the active transducer.

What is desirable is an APR system which gives the designer additional low-frequency tuning flexibility, while preserving the mid- and high-frequency output of the active transducer.

### BRIEF DESCRIPTION OF THE DRAWINGS

FIG. 1 shows a basic APR loudspeaker enclosure according to the prior art.

FIG. 2 shows an APR loudspeaker enclosure with an internally-ported, self-enclosed housing for the APR assembly, according to the prior art.

FIG. 3 shows the housed APR assembly of FIG. 2 in perspective view.

FIG. 4 shows an APR band-pass enclosure, in which the active transducer is entirely internal in a band-pass enclosure, according to the prior art.

FIG. 5 shows another APR band-pass enclosure, with a first APR driven by the front surface of the entirely internal active transducer, and a second APR driven by the back surface of the entirely internal active transducer, according to the prior art.

FIG. 6 shows an improved APR loudspeaker system according to one embodiment of this invention, with a cutaway view.

FIG. 7 shows the improved APR loudspeaker system of FIG. 6 from a different angle, without a cutaway, and with an enclosure side panel removed for viewing the other components.

FIG. 8 shows an improved APR loudspeaker system according to another embodiment of this invention.

FIG. 9 shows the improved APR loudspeaker system of FIG. 8 from a different angle, without a cutaway, and with an enclosure side panel removed for viewing the other components.

FIG. 10 shows an improved APR loudspeaker system according to yet another embodiment of this invention.

FIG. 11 shows the improved APR loudspeaker system of FIG. 10 from a different angle, without a cutaway.

FIG. 12 shows one embodiment of an enclosure such as may be used in the improved APR loudspeaker system of FIG. 10.

FIG. 13 shows a cross-section view of the enclosure of FIG. 12.

FIG. 14 shows an embodiment using flat piston passive radiators.

FIG. 15 shows one embodiment of an in-wall improved APR loudspeaker system.

FIG. 16 shows the loudspeaker system of FIG. 15 in cutaway view.

FIG. 17 shows another embodiment of an in-wall CLAPR loudspeaker system.

FIG. 18 shows the loudspeaker system of FIG. 17 in cutaway view.

FIG. 19 shows a free-standing loudspeaker having a slot-loaded APR.

FIG. 20 shows a free-standing loudspeaker having a ported, chamber-loaded APR.

FIG. 21 shows a free-standing loudspeaker having a chamber-loaded APR driving a pair of passive radiators.

FIG. 22 shows a free-standing loudspeaker having a compound loading transducer pair driving the APR.

FIG. 23 shows a free-standing loudspeaker having a plurality of optional ports.

FIG. 24 shows a loudspeaker in which an APR is driven by a compound driver.

FIG. 25 shows the loudspeaker of FIG. 24 enhanced with thermal chimneys for cooling sealed chambers which are heated by transducer motors.

FIG. 26 shows the loudspeaker of FIG. 24 enhanced with a chamber-loading add-on enclosure.

FIG. 27 shows the chamber-loading add-on enclosure of FIG. 26.

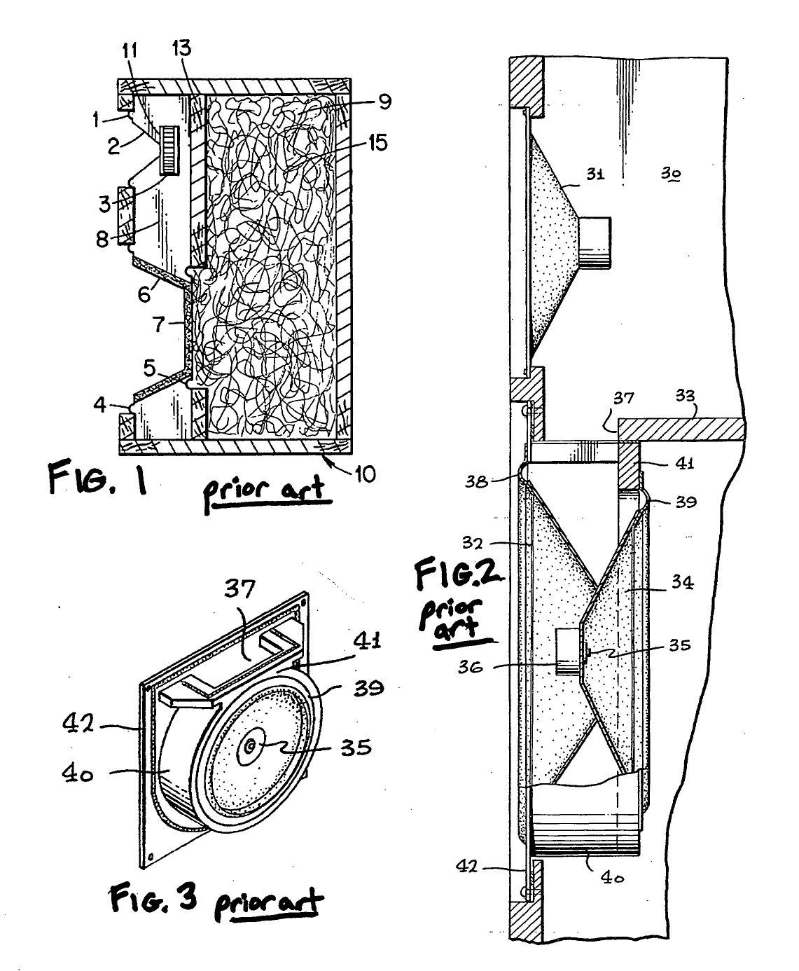

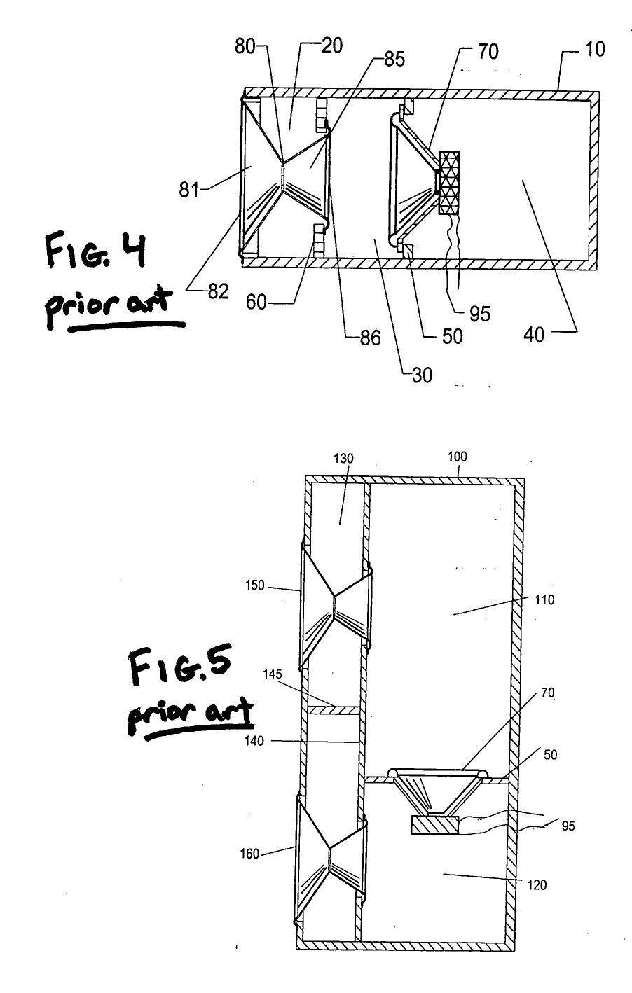

### DETAILED DESCRIPTION OF THE CHAMBER-LOADED APR

The invention will be understood more fully from the detailed description given below and from the accompanying drawings of embodiments of the invention which, however, should not be taken to limit the invention to the specific embodiments described, but are for explanation and understanding only.

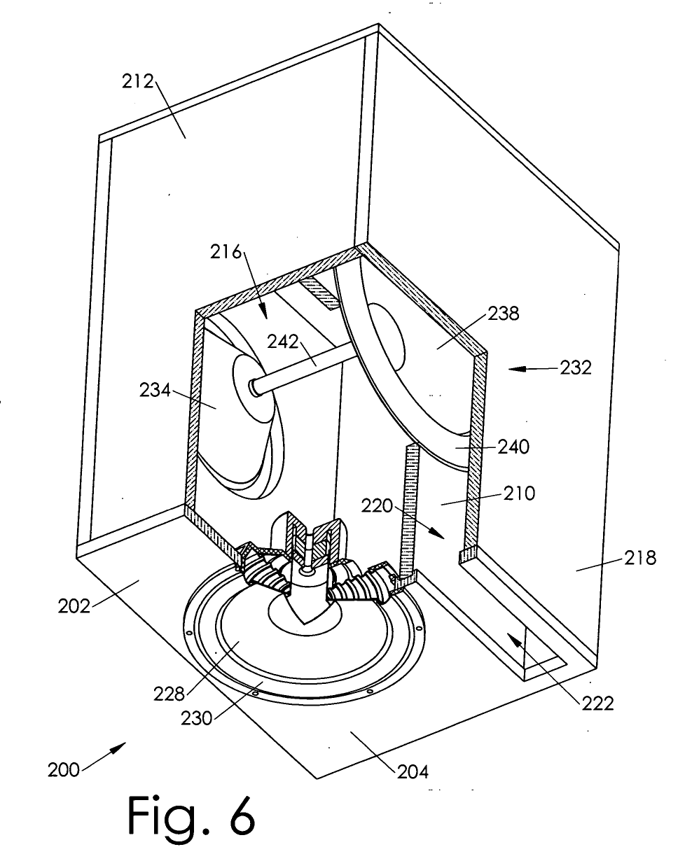

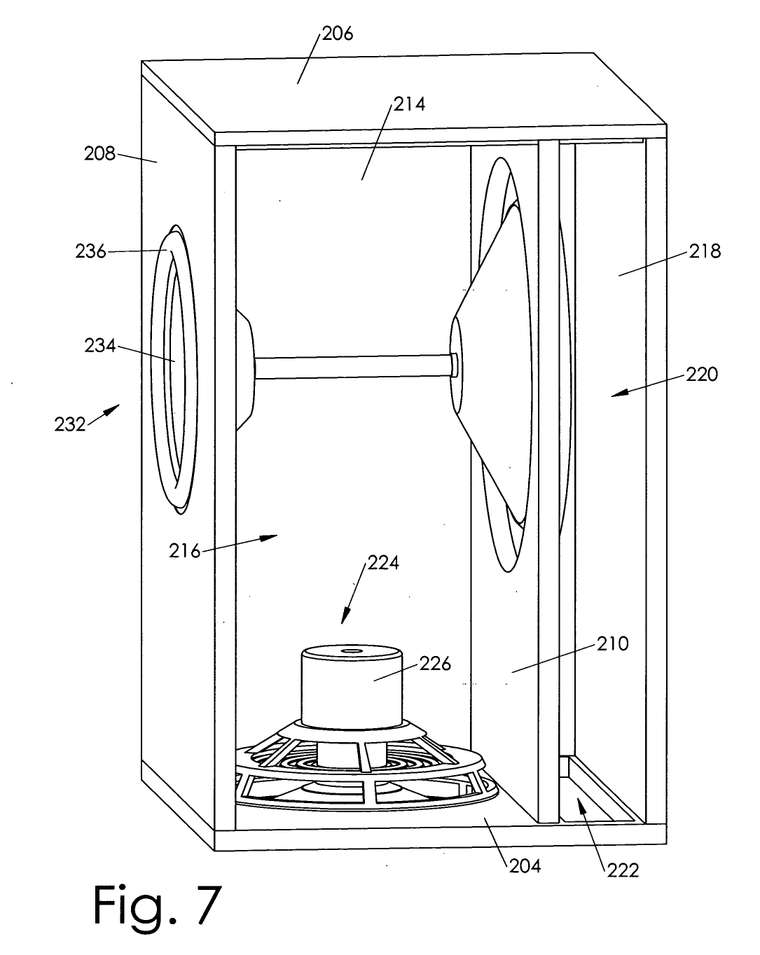

FIGS. 6 and 7 illustrate one embodiment of a chamber-loaded APR (CLAPR) 200 including an enclosure 202 according to one embodiment of the present invention. The enclosure includes a front baffle 204, a back baffle 206, a first side baffle 208, a second side baffle 210 opposite the first side baffle, a third side baffle 212, and a fourth side baffle 214 opposite the third side baffle, which together enclose a first enclosed air volume 216. The front baffle, back baffle, third side baffle, and fourth side baffle extend beyond the second side baffle and, together with a fifth side baffle 218 enclose a second enclosed air volume 220. A vent or slot 222 through the front baffle couples the second enclosed air volume to the external ambient.

An active transducer 224 having a motor structure 226 and a diaphragm 228 is suspended and sealed in an opening through the front baffle of the enclosure by a surround 230 (typically via a frame of the active transducer). In most instances, it will be desirable to orient the active transducer with its motor structure within the enclosed air space. This gives a smaller overall package, improved high frequency response, and a cleaner visual appearance than if the transducer were reversed with the motor structure outside the enclosure. However, the invention will work either way.

An APR assembly 232 is also coupled to the enclosure. A first diaphragm 234 of the APR assembly is suspended and sealed in an opening through the first side baffle by a surround 236. A second diaphragm 238 of the APR assembly is suspended and sealed in an opening through the second side baffle by a surround 240. The two diaphragms are rigidly coupled together. In the embodiment shown, they are coupled by a rod 242.

The back surfaces of the first and second diaphragms of the APR assembly are in contact with the first enclosed air volume. Typically, but not necessarily, the second diaphragm is larger than the first diaphragm. When the active transducer operates and de/pressurizes the enclosed air volume, the APR will oscillate according to the tuning of the overall system (enclosed volume, suspension compliance, diaphragm geometries, and so forth). The exterior surface of the first diaphragm will generate sound into an air space which may advantageously be isolated (by e.g. a ceiling panel or dividing wall, not shown) from the listening air space. The exterior surface of the second diaphragm will generate sound into the second enclosed air volume, which is vented into the listening air space in a location close to the active transducer and in a propagation direction substantially parallel with the movement of the transducer's diaphragm.

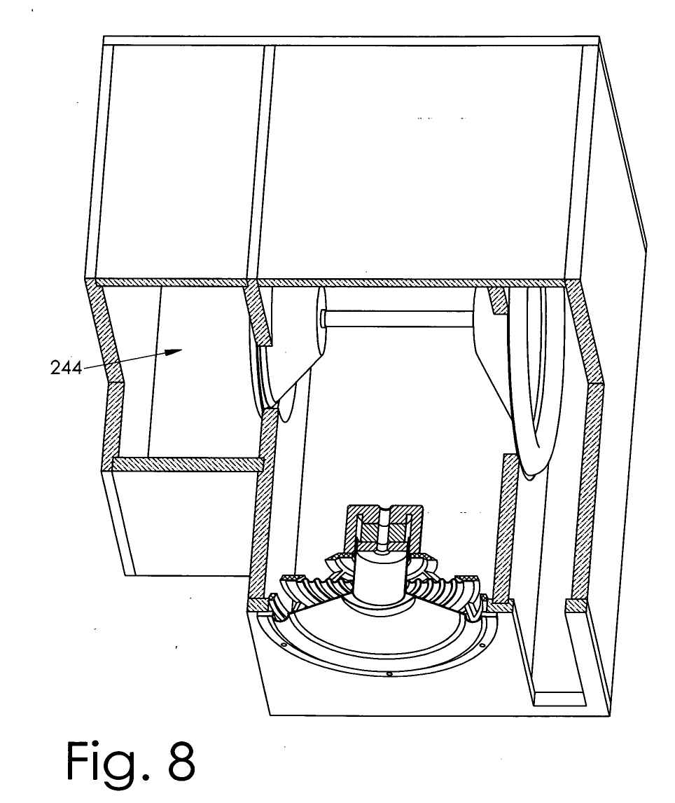

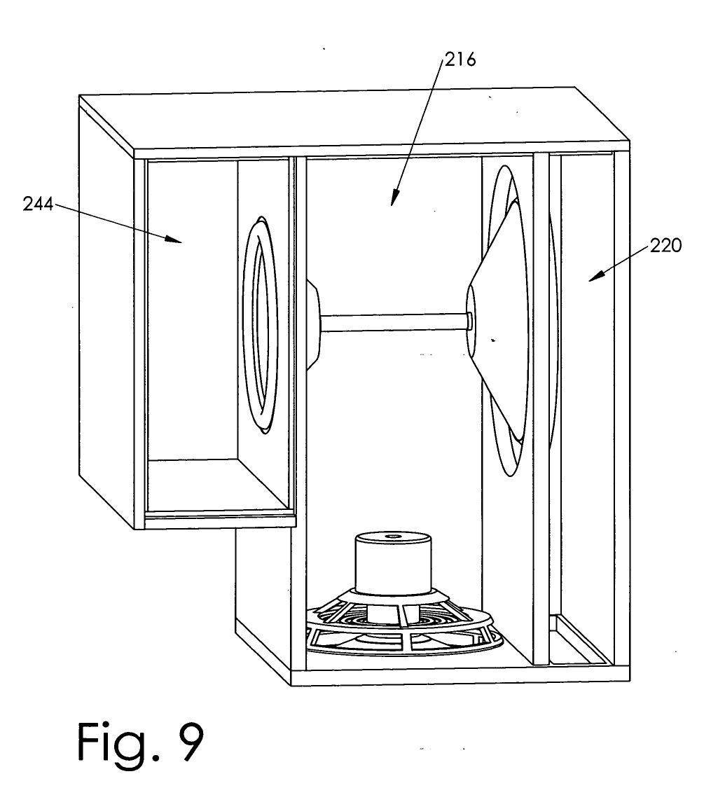

FIGS. 8 and 9 illustrate an embodiment of a CLAPR similar to that of FIGS. 6 and 7, with the addition of baffles enclosing a third air volume 244 with which the first passive diaphragm's exterior surface is in contact. The enclosure also encloses a main enclosed air volume 216 and a slot vented enclosed volume 220.

In either embodiment, the CLAPR is especially well-suited for use as an in-ceiling or in-wall loudspeaker. It is also especially well-suited for use in automotive applications, such as in a rear deck mounted loudspeaker. When mounting the CLAPR, the front baffle is positioned to face into the room (or the listening area), where the front surface of the active transducer's diaphragm can broadcast sound, and where the vent can broadcast additional low frequency reinforcing sound from the second diaphragm. The sound from the first (smaller) diaphragm is directed into e.g. the attic air space above the ceiling (or into the air space enclosed within the wall). In the second embodiment (shown in FIGS. 8 and 9),-the additional baffles enclose the sound from the first diaphragm, effectively sealing its output and preventing it from canceling output of the second diaphragm, thereby allowing this enclosure to be used as part of a free-standing speaker system which is suitable for being used as an in-room speaker (not ceiling mounted).

The APR serves to boost the low frequency sound produced by the loudspeaker. This raises the efficiency of the loudspeaker. It also enables, for a given desired low frequency sound pressure level, a smaller active transducer to be used; this, in turn, improves the high frequency performance of the loudspeaker.

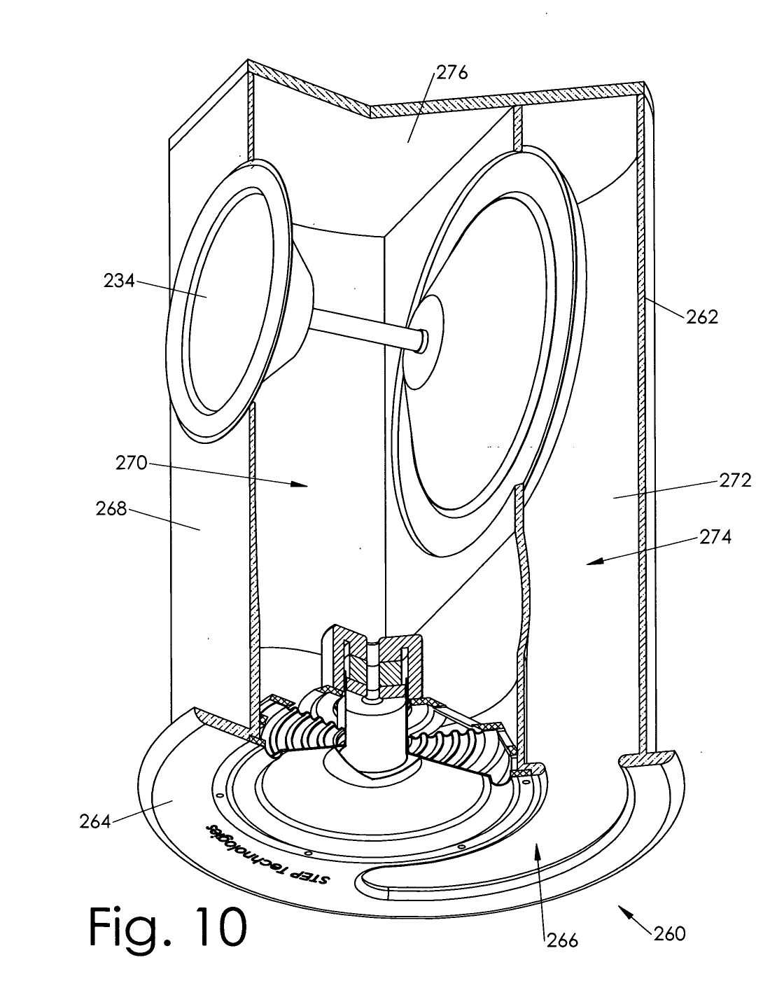

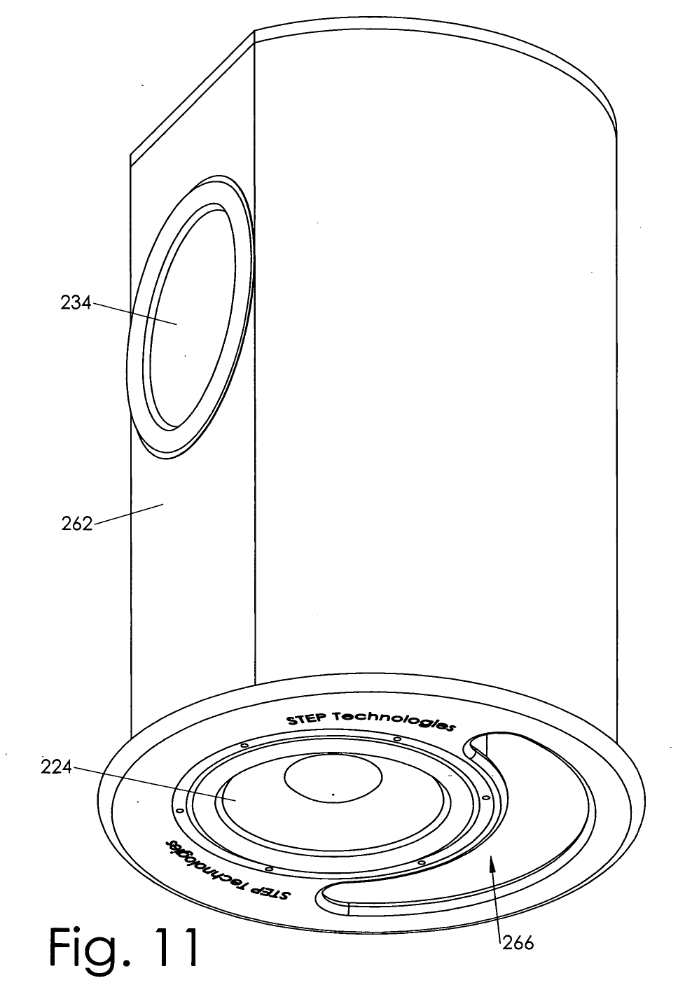

FIGS. 10 and 11 illustrate a third embodiment of a CLAPR loudspeaker system 260 according to this invention, configured as a drop-in replacement for existing “can light” style ceiling-mounted loudspeakers. The loudspeaker includes a generally cylindrical housing 262 which includes a front baffle portion 264 to which the active transducer is mounted and through which the CLAPR vent 266 extends. A first housing portion 268 encloses an air volume 270 which is in contact with the back surface of the active transducer and the back surfaces of the APR diaphragms. The front surface of the first diaphragm 234 is exposed to the ambient air in the attic. A generally semi-cylindrical second housing portion 272 encloses an air volume 274 which is in contact with the front surface of the second diaphragm and which is vented through the front baffle by the vent 266. In some embodiments, such as those manufactured of injection molded plastic, a top cap 276 seals the enclosed air volumes.

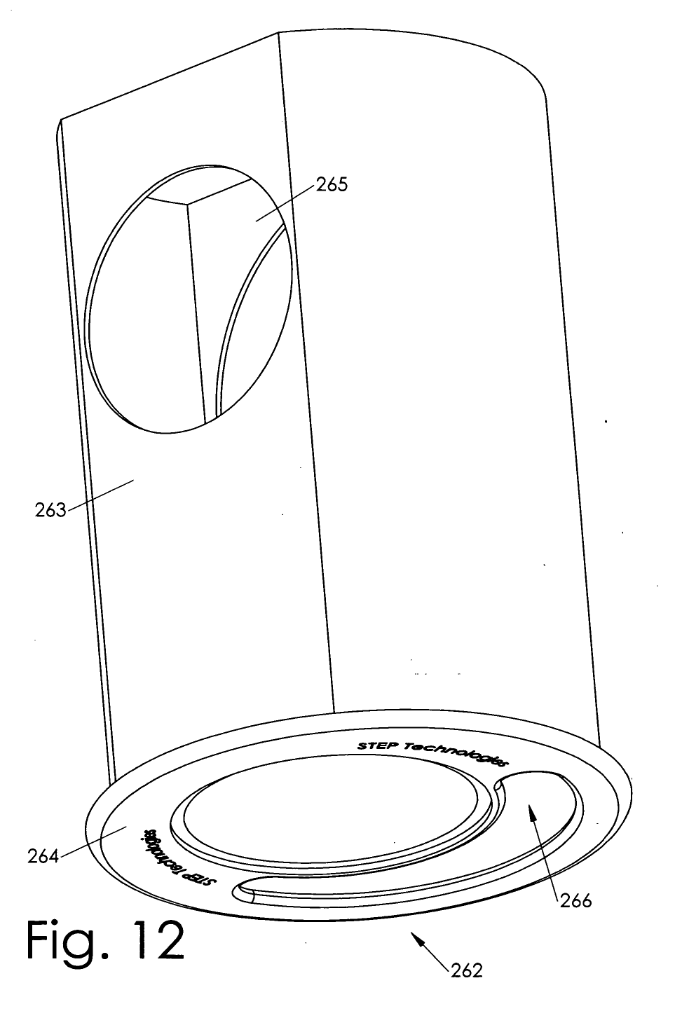

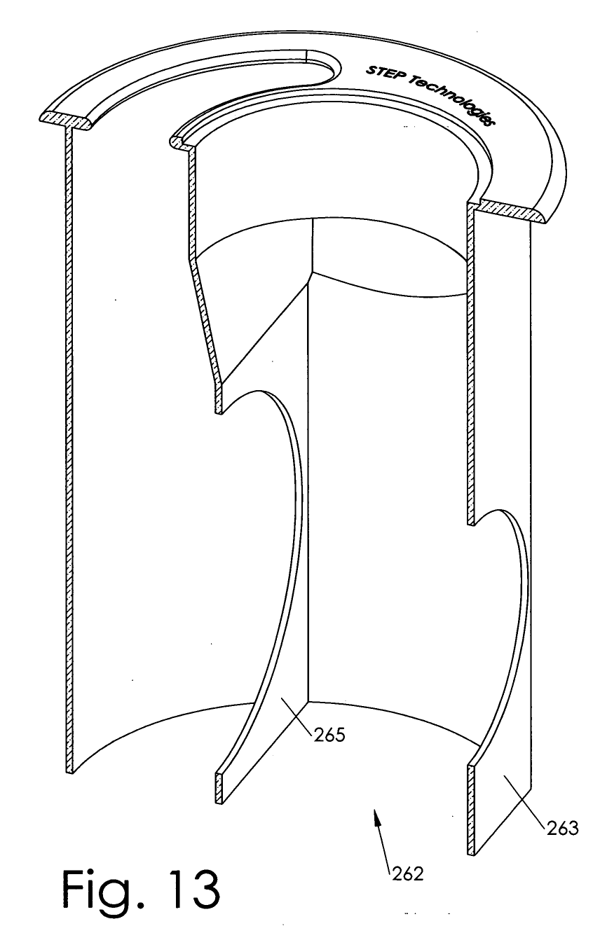

FIGS. 12 and 13 illustrate the enclosure of FIGS. 10 and 11, without the top cap. In the embodiment shown, the enclosure includes planar and substantially parallel portions 263, 265 to which the CLAPR's diaphragms (not shown) can be coupled.

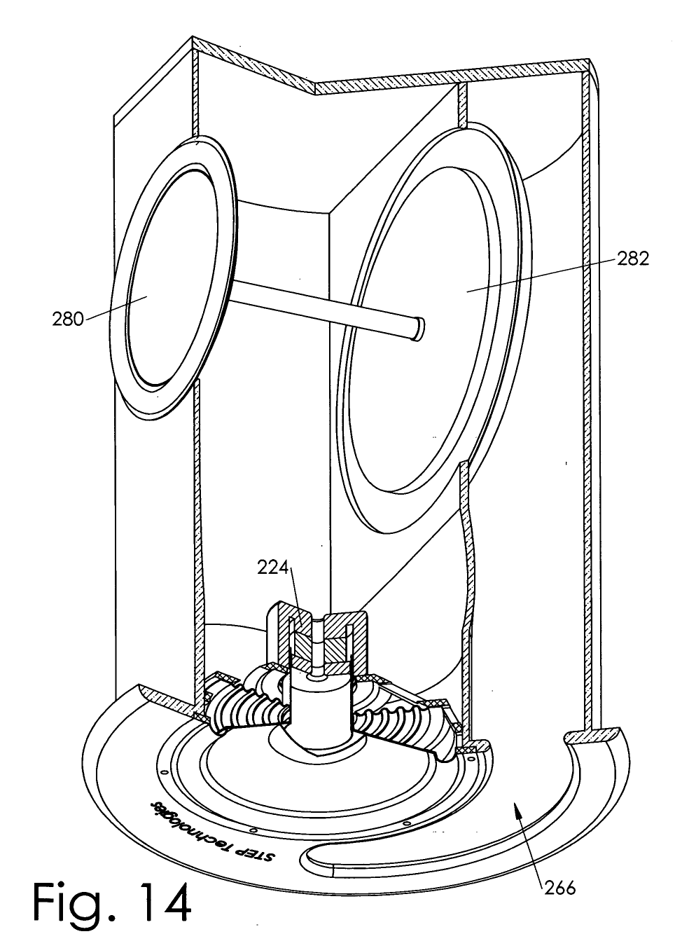

FIG. 14 illustrates an CLAPR loudspeaker system which uses flat piston diaphragms 280, 282 rather than cones.

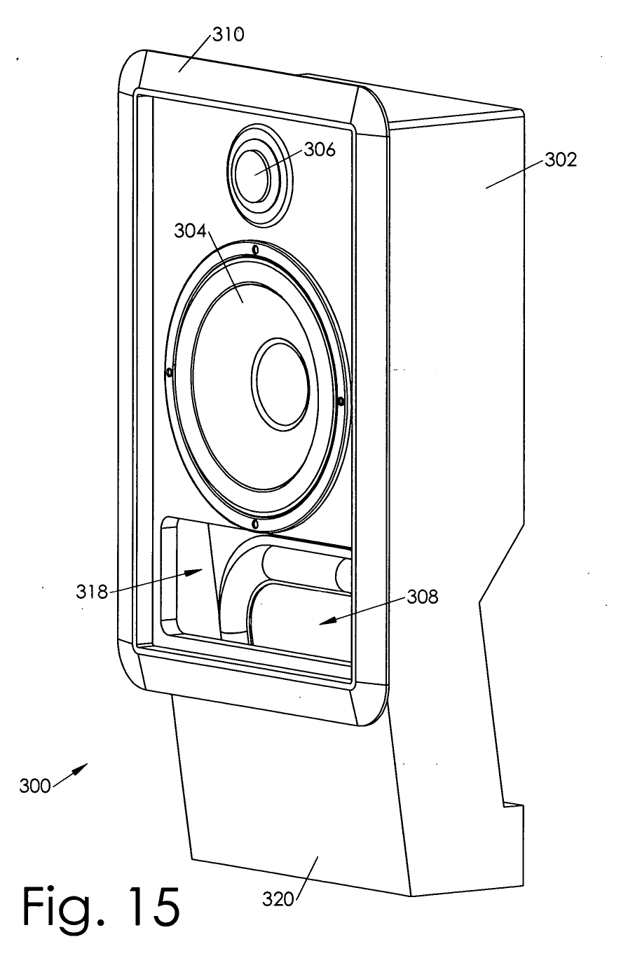

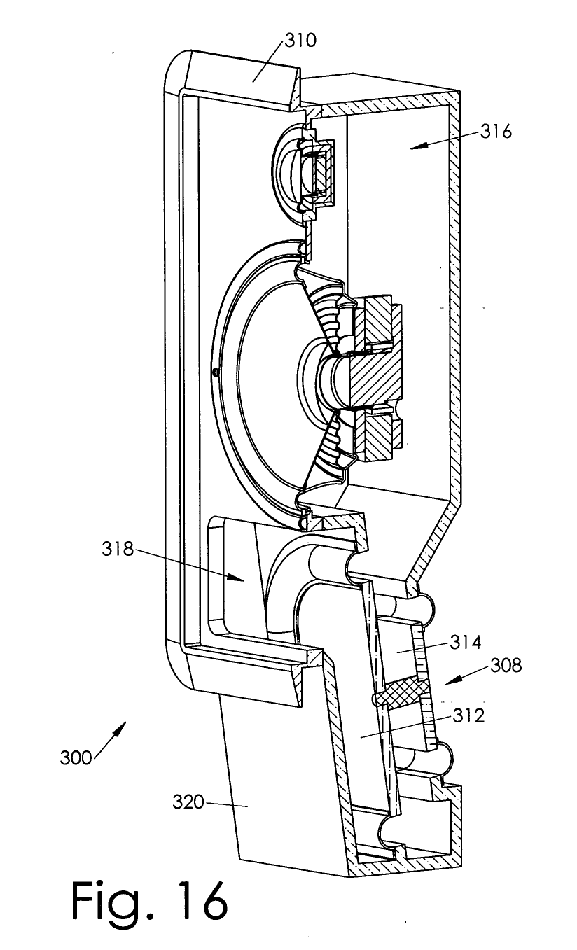

FIGS. 15 and 16 illustrate an in-wall CLAPR loudspeaker system 300 according to another embodiment of this invention. The loudspeaker system includes a housing 302 to which are mounted a woofer driver 304, a tweeter driver 306, and an CLAPR 308. An optional flange or lip 310 assists in wall-mounting the enclosure, preventing it from falling into a hole cut in the wall (not shown). The back surfaces of the woofer's diaphragm, the CLAPR's large diaphragm 312, and the CLAPR's small diaphragm 314 are in contact with an enclosed air volume 316 within the enclosure. Typically, the tweeter may be of the self-enclosed variety such that it may extend into the enclosed air volume without the back surface of its diaphragm being affected by back waves from the woofer. A vent 318 through the front surface of the enclosure permits sound from the front surface of the CLAPR's large diaphragm to be projected into the listening space, coupling into the same air space that is being acoustically driven by the woofer and tweeter.

Advantageously, the enclosure may include a projection 320 which extends outwardly beyond the perimeter of the flange and which houses at least a portion of the CLAPR. This projecting portion serves to reduce the visible footprint of the loudspeaker system, as seen from the listening side, as the projecting portion will be hidden within the wall (or ceiling).

Advantageously, the depth of the enclosure, from the back of the lip to the rearmost point, may be sufficiently shallow to permit the enclosure to be mounted in a conventional wall. For example, many homes are built using interior walls of traditional “drywall over 2×4 stud” construction. Commonly, drywall is ⅝″ thick, and 2×4 studs are a nominal 3.5″ thick. In this instance, it is desirable that the enclosure not extend more than 4.125″ rearward beyond the rear surface of the flange. Often, ceilings are built with 2×6 studs or even 2×12 studs or 2×10 laminated beams. Armed with the teachings of this disclosure, the skilled designer will be readily able to select enclosure dimensions to suit the application at hand.

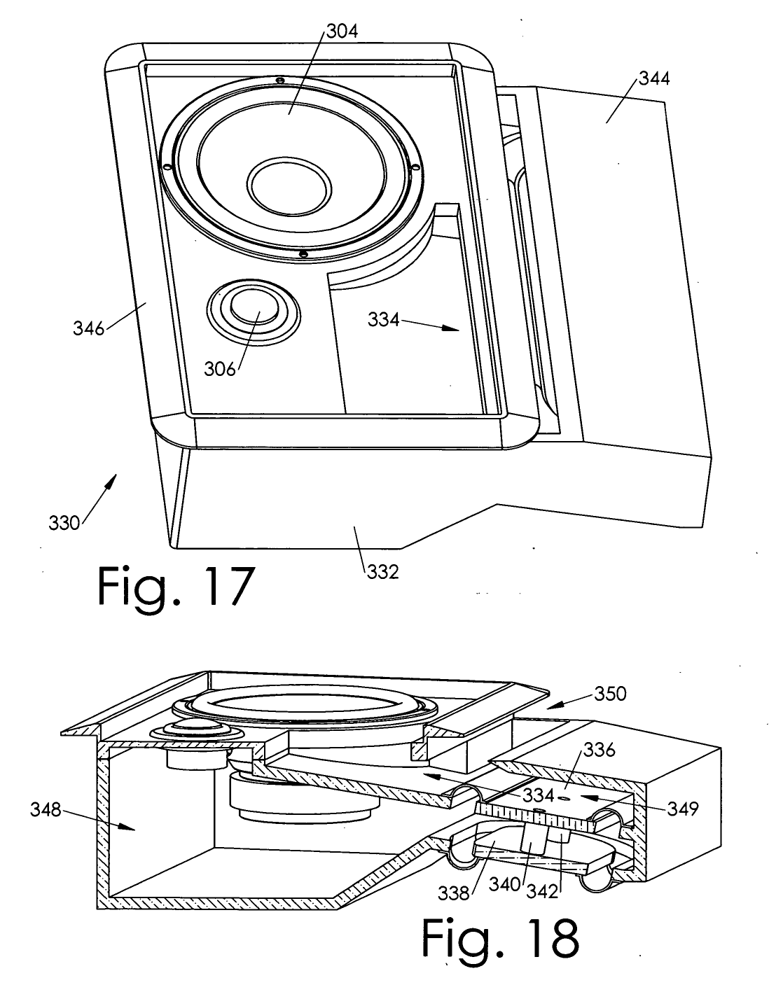

FIGS. 17 and 18 illustrate another embodiment of an in-wall CLAPR loudspeaker system 330. The loudspeaker system includes an enclosure 332 which houses e.g. a woofer 304 and a tweeter 306. A slot (through which the shaft of arrow 334 passes in FIG. 18) vents the CLAPR. The CLAPR includes a large diaphragm 336 and a small diaphragm 338. The CLAPR diaphragms are rigidly coupled by a pair of shafts 340, 342. In the embodiment illustrated, the CLAPR diaphragms have a substantially “racetrack” shape, and they are of substantially the same dimension in the left-to-right direction in FIG. 18, while the large diaphragm is taller (in the direction perpendicular to the page) than the small diaphragm. The enclosure includes an extension 344 which extends beyond the visible (to the listener) perimeter of a flange 346 which facilitates mounting the enclosure to a wall (not shown).

Optionally, the wall itself may, together with the enclosure, enclose the enclosed air volume 349 with which the front surface of diaphragm 336 is in contact. Arrow 350 denotes a region behind the flange, through which sound would pass (in addition to passing out the slot), but for the fact that the wall's e.g. drywall is sandwiched between the body of the enclosure and the flange, sealing this escape path and forcing the sound to exit via the slot.

It should be noted that residential walls and ceilings-are not the only applications in which many of the foregoing embodiments may be found useful. For example, audio loudspeakers mounted in the rear deck of an automobile are traditionally 6″ or 6″×9″ coaxial loudspeakers. These are capable of producing some amount of bass, but their bass performance can be greatly increased by the usage of the CLAPR invention. Or, CLAPR-equipped loudspeakers can be used in professional audio equipment, or in boats, or in any other application in which it is desirable to increase bass response and/or reduce the diameter of the active transducer.

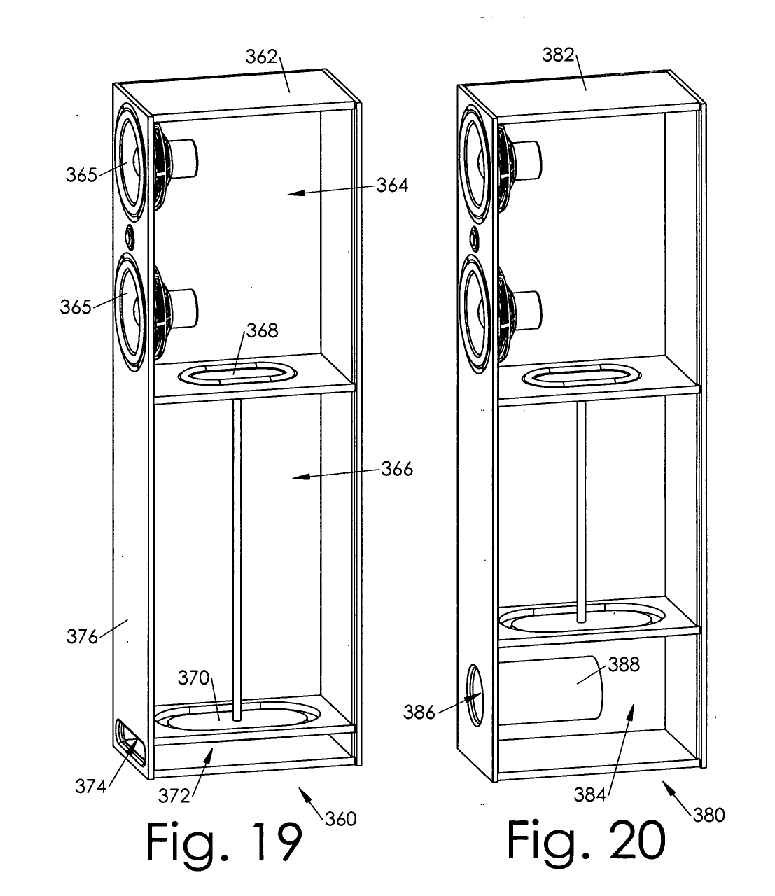

FIG. 19 illustrates an exemplary embodiment of a free-standing loudspeaker 360 such as may be useful in e.g. a home audio system. The loudspeaker has an enclosure 362 which encloses a first volume of air 364 with which the back surfaces of one or more transducers 365 are in contact, a second volume of air 366 with which the back surfaces of the APR diaphragms 368, 370 are in contact, and a third volume of air 372. The front surface of the small diaphragm is in contact with the first enclosed air volume, and the front surface of the large diaphragm is in contact with the third enclosed air volume. The large diaphragm is slot-loaded by a slot 374 extending from the third enclosed air volume to the listening space. Typically, although not necessarily, the slot and the transducers extend through a same face 376 of the enclosure, such that their sound pressure is propagated into the listening space in a same direction. Slot-loading an APR gives it a higher effective moving mass, by increasing the air mass loading. Slot-loading also allows the air moved by a large surface area diaphragm to be channeled through the much smaller cross-sectional area of a slot.

In previous figures, the active transducer is shown as driving the enclosed air volume which is also in contact with back (facing) surfaces of the APR diaphragms. FIG. 19 illustrates that, alternatively, the active transducer can drive the enclosed air volume which is in contact with the “rear” APR diaphragm (typically but not necessarily the small diaphragm).

FIG. 20 illustrates another embodiment of a free-standing loudspeaker 380 in which the enclosure 382 is not slot-loaded, but the third enclosed air volume 384 is suitably sized and is ported to the listening space by a port 386. The port may include a port tube 388 of suitable dimensions to tune the enclosure.

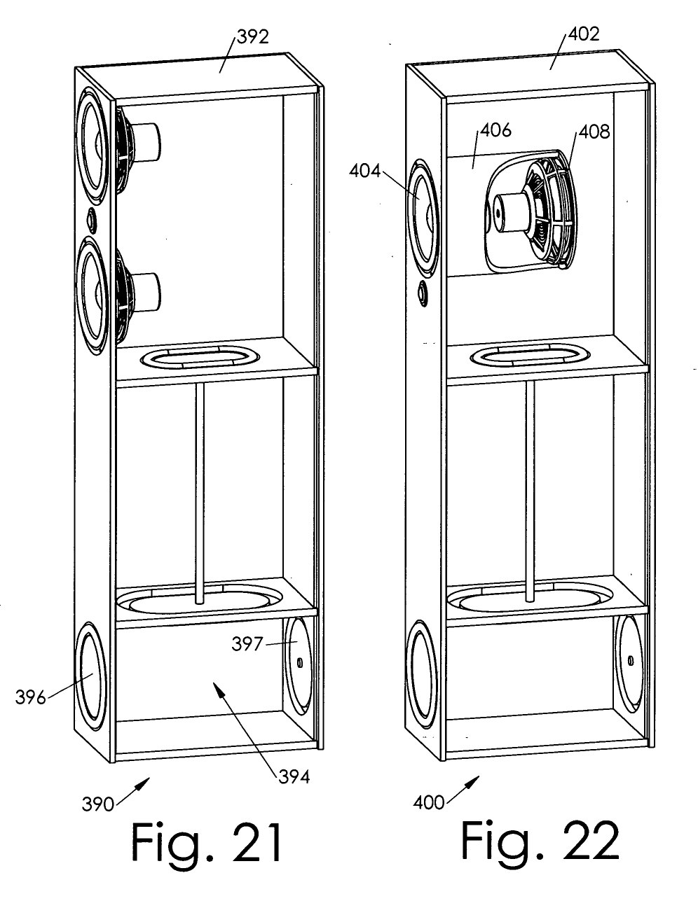

FIG. 21 illustrates another embodiment of a free-standing loudspeaker 390 in which the enclosure 392 is neither slot-loaded nor ported, but the third enclosed air volume 394 is coupled to the listening space by a pair of passive radiators 396, 397. The skilled designer will dimension the APR diaphragms, the passive radiator diaphragms, the transducer diaphragms, and the three enclosed air volume chambers according to the needs of the application at hand. In general, it should be noted that third air chamber acts as an additional resonance chamber, allowing the designer to further tune the system to achieve the desired low frequency response.

FIG. 22 illustrates another embodiment of a free-standing loudspeaker 400 including an enclosure 402 such as has been described, and in which the APR is driven by a compound loading transducer pair which includes a first active transducer 404 whose diaphragm front surface is exposed to the listening space, a compound loading tube enclosure 406 coupled to the first transducer, and a second active transducer 408 coupled to the other end of the tube. The transducers can either be coupled back-to-back as shown and driven with opposite phase signals, or the second transducer can be turned around to the same orientation as the first transducer and driven with the same phase signal as it. Only one transducer is exposed to drive the small APR diaphragm, which halves the amount of air displacement that could nominally be achieved if both transducers were exposed to drive it in parallel (as in e.g. FIG. 21); However, the APR leverage and other factors present a significant additional load on the transducer motors. Arranging the transducers in series, via the compound loading enclosure tube, doubles the motor “horsepower” which is driving the load, which approximately halves the load on each motor. This enables the use of cheap, already mass produced, off-the-shelf, transducers to be used in an APR system, avoiding the need to develop custom transducers with extremely powerful motors. The advantages and disadvantages of compound loading, such as a smaller required enclosure volume and reduced efficiency, still apply.

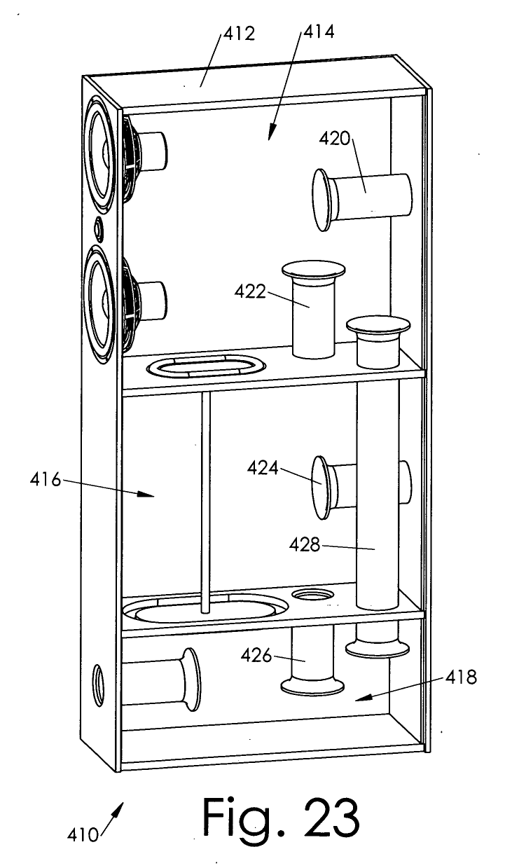

FIG. 23 illustrates a loudspeaker 410 having an enclosure 412 which encloses a first chamber 414, a second chamber 416, and a third chamber 418 similar to those which have been described above. In addition to or in lieu of the porting options described above, the enclosure may have a port 420 from the first chamber to the listening space, a port 422 from the first chamber to the second chamber, a port 424 from the second chamber to the listening space, a port 426 from the second chamber to the third chamber, and/or a port 428 from the first chamber to the third chamber. These ports may be of the tube port variety as shown, or they may be passive radiators, or they may be mere holes or slots, or they may be of the insulation-filled port (resistive loading) variety, or other suitable configuration. Ports, holes, vents, passive radiators, insulation-filled ports, and the like may be termed acoustic couplers. The loudspeaker may utilize any combination of type and number of acoustical couplers necessary to achieve the frequency response and/or performance desired by the designer.

### Detailed Description of Compound Driver APR

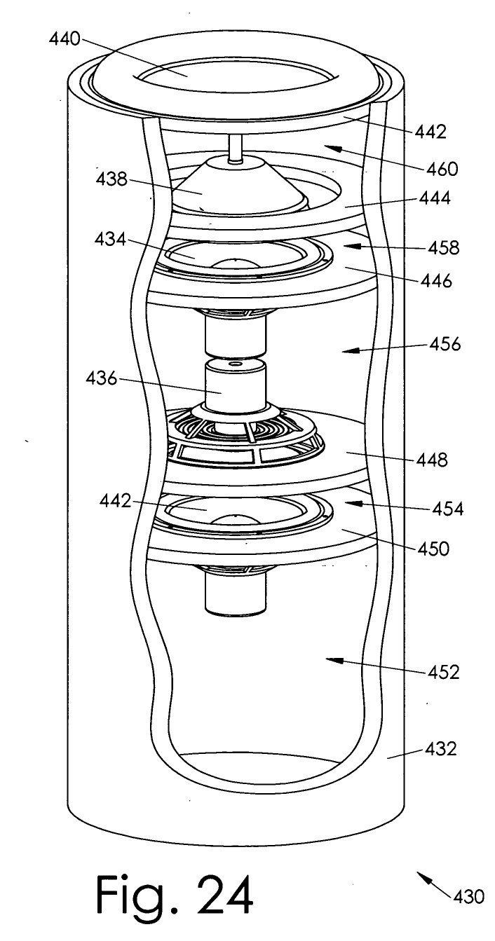

FIG. 24 illustrates a loudspeaker 430 which utilizes a novel combination of an APR and a compound driver. In the embodiment shown, the enclosure 432 has a tubular shape, but other embodiments could use a variety of other shapes. The basic principle of a compound driver is that it includes two active transducers operating in series rather than in parallel; the first active transducer 434 is the only one of the compound driver transducers which generates sound pressure into the listening space, and the second active transducer 436 generates sound pressure against the back surface of the first transducer. In this invention, the first active transducer is producing sound pressure against the small diaphragm 438 of an APR, rather than directly into the listening space, and the large diaphragm 440 of the APR produces sound pressure directly into the listening space.

A further improvement is made by adding an optional third active transducer 442 to the compound driver assembly in series with the first two. In the embodiment shown, the first and third active transducers are oriented in a first direction, while the second active transducer is oriented in the opposite direction. However, because the second active transducer's voice coil is connected in a reversed polarity, the diaphragms of all three transducers move together in the same direction. The result is three motor's strength driving a single diaphragm's air mass resistance. Fourth etc. active transducers can also be added in series to the compound driver assembly.

In the embodiment shown, the large APR diaphragm is coupled to a front baffle 442, the small APR diaphragm is coupled to a baffle 444, and the three active transducers are coupled respectively to three additional baffles 446, 448, 450. The baffles are located within the enclosure at positions which will be determined according to the needs of the particular application at hand, taking into account the characteristics of the APR, the active transducers, the desired low frequency response, and so forth. A first sealed chamber 452 behind the rearmost active transducer is, in essence, the equivalent of the conventional and familiar subwoofer enclosure, whose volume is largely responsible for the tuning characteristics of the enclosure. The series of intra-transducer sealed chambers 454, 456 in the compound driver assembly and the sealed chamber 458 between the first transducer and the back of the APR serve as fluid coupling between the front (toward the APR, regardless of transducer orientation) surface of one transducer's diaphragm and the rear (away from the APR, regardless of transducer orientation) surface of the next transducer's diaphragm. In general, it will be desirable to keep these enclosed volumes as small as possible, to minimize hysteresis, maximize coupling efficiency, and reduce the overall size of the loudspeaker. As can be seen, reversing the second transducer's orientation increases the volume in the chamber 456; in some cases, as will be explained below, there may be reasons for doing so. In general, it will be desirable to maximize the volume in the sealed chamber 460 between the diaphragms of the APR.

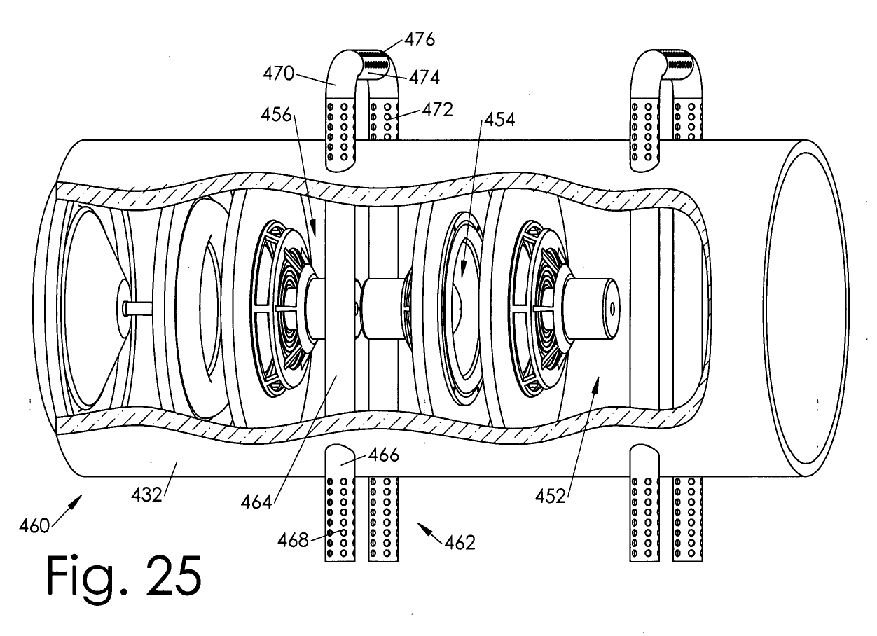

FIG. 25 illustrates another embodiment of a loudspeaker 460 which combines an APR with a compound driver assembly. One problem that tends to arise with compound loaded drivers, perhaps more so than in conventional systems, is that the multiple transducer motors generate heat in a relatively small, non-vented enclosed volume. Thermal chimneys 462 can be added to the loudspeaker to cool the transducer motors. At its simplest, a suitable thermal chimney includes a tube 464 of thermally conductive material such as aluminum which extends through the enclosure so as to be in contact with the enclosed volume 456 to be cooled, and whose walls are substantially sealed such that there is little or no pressure leakage in or out of the chamber. The ends of the thermal chimney are open to permit air to flow from the external ambient in one end of the thermal chimney, through the hollow thermal chimney, and out the other end. The sealed chamber heats the enclosed portion of the outer walls of the thermal chimney, the material of the thermal chimney conducts this heat to the inner walls, and the airflow through the chimney extracts the heat from the inner walls, cooling the sealed chamber.

In the enhanced embodiment shown, the thermal chimney is constructed as an elongated U-shaped double chimney, which also serves as a handle for carrying the loudspeaker. Lower portions 466 of the tubes, which extend out the bottom of the enclosure may optionally be provided with vent holes 468 such that air will flow into the chimney tubes even if the bottoms of the tubes are obstructed by e.g. being set on the ground. Upper portions 470 of the tubes which extend out the top of the enclosure may similarly be provided with vent holes 472. The handle portion 474 between the tubes may be provided with vent holes 476 to vent air from both tubes. For comfort in carrying the loudspeaker, the vent holes may be omitted from the bottom of the handle.

Thermal chimneys may be added to any chambers of the loudspeaker. They will, however, be most advantageous if they extend through the same chambers which contain transducer motors. In the embodiment shown, the middle transducer is reversed, so its motor is in the same chamber 456 as the motor of the first transducer.

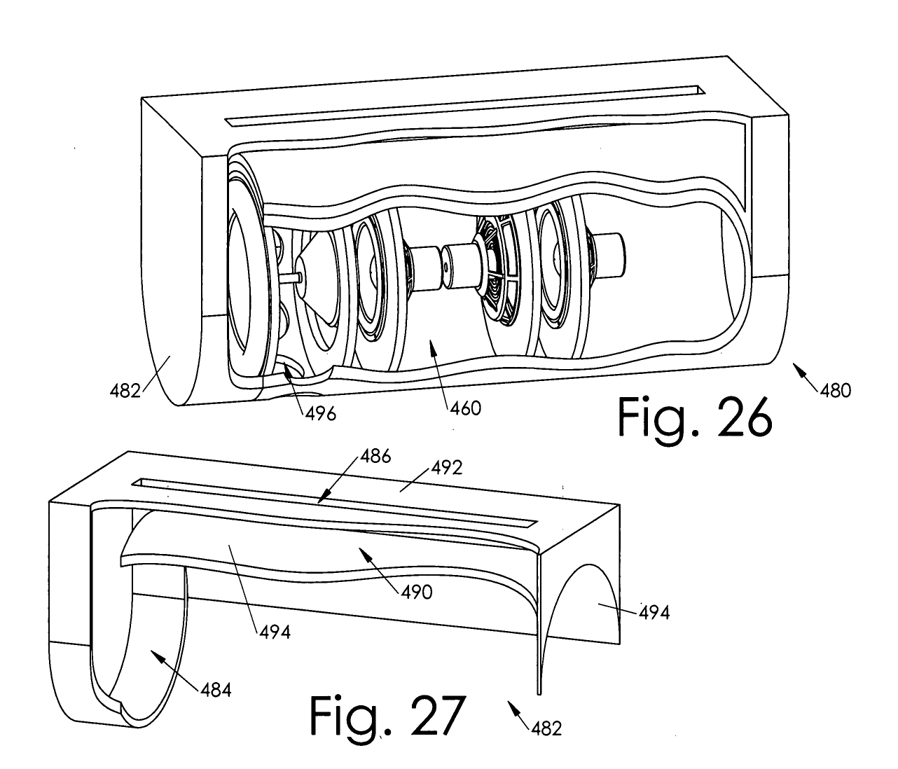

FIGS. 26 and 27 respectively illustrate a loudspeaker 480 which combines a chamber-loaded APR with a compound driver assembly, utilizing an add-on chamber-loading enclosure 482 which can be added to the loudspeaker 460 of FIG. 24 to construct such a loudspeaker.

The enclosure 482 includes an open-ended chamber 484 which mates with the APR end of the loudspeaker 460 to form a chamber-loading volume. The enclosure includes a slot 486 (or port, passive radiator, etc.) which extends from the chamber-loading volume to the listening space.

In the embodiment shown, the slot extends into an intermediate chamber 490 which extends laterally from the chamber-loading volume, between a top baffle 492 which can be affixed to the underside of an automobile rear deck, and a lower baffle 494 which can be affixed to the exterior of the loudspeaker 460. In other embodiments, the slot could be oriented in a different direction, and/or could have a vertical ducted portion extending through the automobile rear deck, and so forth.

In one embodiment, the chamber between the diaphragms of the APR is significantly ported by one or more sizeable holes 496 such that, when the loudspeaker is mounted beneath the rear deck of an automobile, the entire volume of the trunk serves as the chamber with which the facing surfaces of the APR diaphragms are in contact.

### CONCLUSION

When one component is said to be “adjacent” another component, it should not be interpreted to mean that there is absolutely nothing between the two components, only that they are in the order indicated.

The various features illustrated in the figures may be combined in many ways, and should not be interpreted as though limited to the specific embodiments in which they were explained and shown.

Those skilled in the art having the benefit of this disclosure will appreciate that many other variations from the foregoing description and drawings may be made within the scope of the present invention. Indeed, the invention is not limited to the details described above. Rather, it is the following claims including any amendments thereto that define the scope of the invention.

What is claimed is:

1. A loudspeaker comprising:
an enclosure including a coupling chamber which is acoustically coupled to a listening space;
an active transducer coupled to the enclosure;
an augmented passive radiator coupled to the enclosure such that (i) it is driven by the active transducer and (ii) it generates sound pressure into the vented chamber.

2. The loudspeaker of claim 1 wherein:
the active transducer is coupled to generate sound pressure into an enclosed air volume between a large diaphragm and a small diaphragm of the augmented passive radiator.

3. The loudspeaker of claim 2 wherein:
the enclosure further includes a chamber enclosing an air volume into which the small diaphragm of the augmented passive radiator generates sound pressure.

4. The loudspeaker of claim 2 wherein:
the active transducer is coupled to the enclosure such that it generates sound pressure into the listening space.

5. The loudspeaker of claim 4 wherein:
the enclosure is configured as an in-ceiling enclosure.

6. The loudspeaker of claim 4 wherein:
the enclosure is configured as an in-wall enclosure.

7. The loudspeaker of claim 4 wherein:
the enclosure is configured as a standalone in-room enclosure.

8. The loudspeaker of claim 1 wherein:
the coupling chamber is vented to the listening space by a slot.

9. The loudspeaker of claim 1 wherein:
the coupling chamber is vented to the listening space by a ducted port.

10. The loudspeaker of claim 1 wherein:
the coupling chamber is coupled to the listening space by a passive radiator.

11. The loudspeaker of claim 1 wherein:
the active transducer comprises a compound driver assembly including a plurality of electromagnetic transducers coupled in series to drive the augmented passive radiator.

12. A loudspeaker comprising:
an enclosure including,
a front face,
a first enclosure structure coupled to the front face and enclosing a first enclosed air volume,
a second enclosure structure enclosing a second enclosed air volume, and
an acoustic coupler extending into communication with the second enclosed air volume;
an active transducer coupled to the front face and having a diaphragm, a back surface of the diaphragm being in contact with the first enclosed air volume; and
an augmented passive radiator coupled to the enclosure and having a back surface in contact with the first enclosed air volume, a second surface exposed to an ambient outside the first and second enclosed air volumes, and a third surface in contact with the second enclosed air volume.

13. The loudspeaker of claim 12 wherein the augmented passive radiator comprises:
a first passive radiator suspended in a first hole through the first enclosure structure; and
a second passive radiator suspended in a second hole through the first enclosure structure and coupled to the first passive radiator.

14. The loudspeaker of claim 13 wherein:
the first passive radiator is rigidly coupled to the second passive radiator.

15. The loudspeaker of claim 13 wherein:
at least one of the first and second passive radiators comprises a cone.

16. The loudspeaker of claim 13 wherein:
at least one of the first and second passive radiators comprises a flat piston.

17. The loudspeaker of claim 12 wherein:
the acoustic coupler extends through the front face.

18. The loudspeaker of claim 17 wherein:
the acoustic coupler extends in a substantially same direction as a direction of movement of the diaphragm of the active transducer.

19. The loudspeaker of claim 12 wherein the enclosure further includes:
a third enclosure structure enclosing a third enclosed air volume which comprises the ambient to which the second surface of the augmented passive radiator is exposed.

20. The loudspeaker of claim 12 wherein:
the enclosure has a substantially cylindrical shape.

21. The loudspeaker of claim 12 wherein:
the acoustic coupler is an open slot.

22. The loudspeaker of claim 21 wherein:
the slot is curved around the active transducer.

23. The loudspeaker of claim 21 wherein:
the active transducer is mounted in the front face off-center in a first direction, and the slot extends through the front face adjacent the active transducer in a second direction substantially opposite the first direction.

24. The loudspeaker of claim 20 wherein:
the enclosure has a diameter substantially matching a diameter of an industry standard can-light sized opening.

25. The loudspeaker of claim 12 wherein the enclosure further includes:
a portion extending beyond the front face and housing at least a portion of the augmented passive radiator;
whereby the loudspeaker can be mounted through a hole in a baffle, leaving the face plate visible while hiding the extending portion behind the baffle.

26. A loudspeaker comprising:
an enclosure enclosing a first volume of air in a first chamber and a second volume of air in a second chamber, the enclosure having a first hole and a second hole extending from an external region into the first chamber, a third hole extending from the first chamber into the second chamber, and a fourth hole extending from the external region into the second chamber;
an active transducer coupled to the enclosure in the first hole such that a first surface of a diaphragm of the active transducer is in contact with the first enclosed volume of air; and
an augmented passive radiator including,
a first APR diaphragm coupled to the enclosure in the second hole such that a back surface of the first APR diaphragm is in contact with the first enclosed volume of air, and
a second APR diaphragm coupled to the enclosure in the third hole such that a back surface of the second APR diaphragm is in contact with the first enclosed volume of air and a front surface of the second APR diaphragm is in contact with the second enclosed volume of air,
the first and second APR diaphragms being substantially rigidly coupled to each other;
whereby, when the active transducer operates and de/pressurizes the first enclosed volume of air, the front surface of the second APR diaphragm de/pressurizes the second enclosed volume of air, whereby the active transducer and the fourth hole produce sound into a listening space.

27. The loudspeaker of claim 26 configured as a free-standing loudspeaker.

28. The loudspeaker of claim 26 configured as a ceiling-mount loudspeaker.

29. The loudspeaker of claim 26 configured as an in-wall loudspeaker.

30. The loudspeaker of claim 26 wherein the enclosure further encloses a third volume of air in contact with a front surface of the first APR diaphragm.

31. The loudspeaker of claim 26 wherein the fourth hole comprises:
an elongated slot.

32. A loudspeaker comprising:
(A) an enclosure enclosing a first volume of air and a second volume of air and including,
a slot-loading vent extending from the second volume of air out through the enclosure in a first direction;
(B) an active transducer coupled to the enclosure so as to have,
a first surface of a diaphragm of the active transducer in contact with the first enclosed volume of air, and
an axis of motion of the active transducer oriented in a second direction;
(C) a first passive radiator coupled to the enclosure so as to have,
a back surface of a diaphragm of the first passive radiator in contact with the first enclosed volume of air, and
an axis of motion of the first passive radiator oriented in a third direction;
(D) a second passive radiator coupled to the enclosure so as to have,
a back surface of a diaphragm of the second passive radiator in contact with the first enclosed volume of air,
a front surface of the diaphragm of the second passive radiator in contact with the second volume of air,
the diaphragm of the second passive radiator substantially mechanically coupled to the diaphragm of the first passive radiator, and
an axis of motion of the second passive radiator oriented in the third direction.

33. The loudspeaker of claim 32 wherein:
the second direction is substantially the same as the first direction.

34. The loudspeaker of claim 33 wherein:
the third direction is substantially perpendicular to the second direction.

35. The loudspeaker of claim 32 wherein:
the third direction is at least 5 degrees out of parallel from the second direction.

36. The loudspeaker of claim 32 wherein:
the enclosure includes a front face through which the active transducer is coupled and through which the slot-loading vent extends.

37. The loudspeaker of claim 36 wherein:
the slot-loading vent is less than two inches away from the active transducer.

38. The loudspeaker of claim 32 wherein:
the enclosure is substantially cylindrical; and
the slot is substantially arc shaped, extending around a perimeter of the active transducer.

39. The loudspeaker of claim 32 wherein the enclosure includes:
a front face through which the active loudspeaker is coupled and through which the slot-loading vent extends;
a body portion coupled to a back side of the front face;
whereby, when the loudspeaker is mounted through a baffle, the front face is visible from a listening area but the body portion is not.

40. The loudspeaker of claim 39 wherein:
the front face includes a flange extending laterally to facilitate mounting the loudspeaker to the baffle.

41. The loudspeaker of claim 39 wherein:
the body portion extends laterally beyond the flange and encloses at least a portion of the passive radiators.

42. A loudspeaker comprising:
an enclosure including a first chamber;
a compound driver assembly coupled to the enclosure and including a plurality of electromagnetic transducers coupled in series to generate sound pressure into the first chamber; and
an augmented passive radiator having a small diaphragm in contact with the first chamber, and a large diaphragm substantially rigidly coupled to the small diaphragm and exposed to generate sound pressure to a listening space.

43. The loudspeaker of claim 42 wherein:
the enclosure further includes a second chamber; and
an end of the compound driver assembly opposite the augmented passive radiator is in contact with the second chamber.

44. The loudspeaker of claim 42 wherein:
the compound driver includes at least three electromagnetic transducers.

45. The loudspeaker of claim 42 wherein:
the enclosure further includes a vented chamber into which the large diaphragm generates sound pressure, and which is vented to the listening space, whereby the augmented passive radiator generates sound pressure into the listening space via the vented chamber.
